(19) United States
(12) Patent Application Publication
(10) Pub. No.: US 2006/0288340 A1
(43) Pub. Date: Dec. 21, 2006

(54) System for acquisition, representation and storage of streaming data

(75) Inventor: Gilad Raz, Mevaseret Tzion (IL)

Correspondence Address: DANIEL J SWIRSKY, 55 REUVEN ST., BEIT SHEMESH, 99544, IL

(73) Assignee: Digital Fuel Technologies, Inc.

(21) Appl. No.: 11/153,492

(22) Filed: Jun. 16, 2005

(51) Int. Cl. G06F 9/44

(52) U.S. Cl. 717/168

(57) ABSTRACT

A method for allowing multiple processes to independently operate on a data set, including iteratively performing in a metaprocess retrieving a data unit from a first data, associating each of the retrieved units with a timestamp, and storing the retrieved data unit together with its timestamp in a second data set, where the timestamp of each subsequent iteration is later than the timestamp of any previous iteration, and iteratively performing in a first data process at least partially concurrently with the metaprocess, retrieving any of the data units from the second data set whose timestamp indicates a time that is prior to a target time, performing an operation on the retrieved data, where any of the data units retrieved in a previous iteration are not again retrieved in a subsequent iteration, and where the target time in a subsequent iteration is later than the target time of any previous iteration.

### FIELD OF THE INVENTION

The present invention relates to data processing in general, and more particularly to the concurrent acquisition and processing of data.

### BACKGROUND OF THE INVENTION

In data processing environments multiple processes often try to access a single set of data. Unfortunately, conflicts may arise between the processes, such as when one process attempts to write to a data set while a second process attempts to read from the same data set. One common technique for avoiding conflicts between multiple processes accessing a single data set is to lock the data set. In this manner, only a single process is able to access the data set at a single point in time. Unfortunately, this may require a process to remain idle while it waits for its turn to access the data, inhibiting the overall productivity of the system.

Another type of problem may occur when a process, such as a one that acquires and processes streaming data, wishes to identify data that has been previously encountered by the process. In streaming data processing, a first process accumulates data and a second process operates on the data while the data continues to be accumulated. Since the second process continually retrieves and processes the data, the second process may wish to differentiate between data it has previously processed and newly accumulated data that it has yet to process. In this scenario, metadata may be used to per data item per process to indicate whether or not an item of data was processed. Additionally, multiple processes may concurrently be active. Unfortunately, this approach requires an allocation of resources for each datum per process, which may be hampered by limitations on scalability.

Moreover, newly accumulated data may invalidate results obtained from previously processed data, such as when the new data requires that previously processed data be updated. In this scenario a process may be affected by updates performed on the data by another process. This problem may be avoided by copying the entire data set for each process, thus enabling each process to independently work on its copy of the data set. Unfortunately, duplicating information may require extensive resources and may further require synchronization between the copies of the data set.

It would be advantageous to enable multiple processes to independently process shared data without locking or duplicating the data set.

### SUMMARY OF THE INVENTION

In one aspect of the present invention a method is provided for allowing multiple processes to independently operate on a data set, the method including the steps of iteratively performing any of the following steps a)-c) in a metaprocess a) retrieving a data unit from a first data, b) associating each of the retrieved units with a timestamp, c) storing the retrieved data unit together with its timestamp in a second data set, where any of the data units retrieved in a previous iteration are not again retrieved in a subsequent iteration, and where the timestamp of each subsequent iteration is later than the timestamp of any previous iteration, iteratively performing any of the following steps d)-e) in a first data process, where the first data process runs at least partially concurrently with the metaprocess d) retrieving any of the data units from the second data set whose timestamp indicates a time that is prior to a target time, e) performing an operation on the retrieved data, where any of the data units retrieved in a previous iteration are not again retrieved in a subsequent iteration, and where the target time in a subsequent iteration is later than the target time of any previous iteration.

In another aspect of the present invention the method further includes iteratively performing any of the following steps f)-g) in a second data process, where the second data process runs at least partially concurrently with the metaprocess and the first data process f) retrieving any of the data units from the second data set whose timestamp indicates a time that is prior to a second data process target time, g) performing a second data process operation on the second data process retrieved data, where any of the data units retrieved in a previous iteration of the second data process are not again retrieved in a subsequent iteration of the second data process, and where the second data process target time in a subsequent iteration of the second data process is later than the second data process target time of any previous iteration of the second data process.

In another aspect of the present invention the performing an operation step includes performing the operation only on the data units retrieved within one of the iterations.

In another aspect of the present invention the method further includes identifying a data disposition action of a data unit in the first data set, being either of a deletion and a modification of the data unit in the first data set, providing an instruction to effect the data disposition action with respect to the data unit in the second data set, and applying the instruction during an iteration of the first data process.

In another aspect of the present invention the method further includes identifying a data disposition action of a data unit in the first data set, being either of a deletion and a modification of the data unit in the first data set, providing an instruction to effect the data disposition action with respect to the data unit in the second data set, applying the instruction during an iteration of the first data process, applying the instruction during an iteration of the second data process, where the applications of the instructions do not affect the data unit within the second data set.

In another aspect of the present invention the method further includes applying the data disposition action to the data unit in the second data set subsequent to the applications of the instructions by the first and second data processes.

In another aspect of the present invention the performing an operation step includes performing a database aggregate operation.

In another aspect of the present invention a method is provided for allowing multiple processes to independently operate on a data set, the method including the steps of iteratively performing any of the following steps a)-b) in a first data process a) retrieving any data units from a data set having a timestamp indicating a time that is prior to a first data process target time, b) performing a first data process operation on the retrieved data, where any of the data units retrieved in a previous iteration of the first data process are not again retrieved in a subsequent iteration of the first data process, and where the first data process target time in a subsequent iteration of the first data process is later than the first data process target time of any previous iteration of the first data process, iteratively performing any of the following steps c)-d) in a second data process c) retrieving any of the data units from the data set whose timestamp indicates a time that is prior to a second data process target time, and d) performing a second data process operation on the second data process retrieved data, where any of the data units retrieved in a previous iteration of the second data process are not again retrieved in a subsequent iteration of the second data process, and where the second data process target time in a subsequent iteration of the second data process is later than the second data process target time of any previous iteration of the second data process.

In another aspect of the present invention the second data process runs at least partially concurrently with the first data process.

In another aspect of the present invention a system is provided for allowing multiple processes to independently operate on a data set, the system including a metaprocess operative to iteratively perform any of the following steps a)-c) a) retrieve a data unit from a first data, b) associate each of the retrieved units with a timestamp, c) store the retrieved data unit together with its timestamp in a second data set, where any of the data units retrieved in a previous iteration are not again retrieved in a subsequent iteration, and where the timestamp of each subsequent iteration is later than the timestamp of any previous iteration, and a first data process running at least partially concurrently with the metaprocess and operative to iteratively perform any of the following steps d)-e) d) retrieve any of the data units from the second data set whose timestamp indicates a time that is prior to a target time, e) perform an operation on the retrieved data, where any of the data units retrieved in a previous iteration are not again retrieved in a subsequent iteration, and where the target time in a subsequent iteration is later than the target time of any previous iteration.

In another aspect of the present invention the system further includes a second data process running at least partially concurrently with the metaprocess and the first data process, and operative to f) retrieve any of the data units from the second data set whose timestamp indicates a time that is prior to a second data process target time, g) perform a second data process operation on the second data process retrieved data, where any of the data units retrieved in a previous iteration of the second data process are not again retrieved in a subsequent iteration of the second data process, and where the second data process target time in a subsequent iteration of the second data process is later than the second data process target time of any previous iteration of the second data process.

In another aspect of the present invention the second data set is operative to perform the operation only on the data units retrieved within one of the iterations.

In another aspect of the present invention the system further includes means for identifying a data disposition action of a data unit in the first data set, being either of a deletion and a modification of the data unit in the first data set, means for providing an instruction to effect the data disposition action with respect to the data unit in the second data set, and means for applying the instruction during an iteration of the first data process.

In another aspect of the present invention the system further includes means for identifying a data disposition action of a data unit in the first data set, being either of a deletion and a modification of the data unit in the first data set, means for providing an instruction to effect the data disposition action with respect to the data unit in the second data set, means for applying the instruction during an iteration of the first data process, means for applying the instruction during an iteration of the second data process, where the applications of the instructions do not affect the data unit within the second data set.

In another aspect of the present invention the system further includes means for applying the data disposition action to the data unit in the second data set subsequent to the applications of the instructions by the first and second data processes.

In another aspect of the present invention the means for performing an operation step includes performing a database aggregate operation.

In another aspect of the present invention a system is provided for allowing multiple processes to independently operate on a data set, the system including a first data process operative to iteratively perform any of the following steps a)-b) a) retrieve any data units from a data set having a timestamp indicating a time that is prior to a first data process target time, b) perform a first data process operation on the retrieved data, where any of the data units retrieved in a previous iteration of the first data process are not again retrieved in a subsequent iteration of the first data process, and where the first data process target time in a subsequent iteration of the first data process is later than the first data process target time of any previous iteration of the first data process, and a second data process operative to iteratively perform any of the following steps c)-d) c) retrieve any of the data units from the data set whose timestamp indicates a time that is prior to a second data process target time, and d) perform a second data process operation on the second data process retrieved data, where any of the data units retrieved in a previous iteration of the second data process are not again retrieved in a subsequent iteration of the second data process, and where the second data process target time in a subsequent iteration of the second data process is later than the second data process target time of any previous iteration of the second data process.

In another aspect of the present invention the second data process runs at least partially concurrently with the first data process.

### BRIEF DESCRIPTION OF THE DRAWINGS

The present invention will be understood and appreciated more fully from the following detailed description taken in conjunction with the appended drawings in which:

FIG. 1A is a simplified pictorial illustration of a system for concurrent processing of data, constructed and operative in accordance with a preferred embodiment of the present invention;

FIG. 1B is a simplified flowchart illustration of a method for concurrent processing of data, operative in accordance with a preferred embodiment of the present invention;

FIG. 2A is a simplified flowchart illustration of a method for processing additive data, operative in accordance with a preferred embodiment of the present invention;

FIGS. 2B, 2C and 2D taken together, constitute a simplified pictorial illustration of a sample data set constructed from an additive data set, operative in accordance with a preferred embodiment of the present invention;

FIG. 3A is a simplified flowchart illustration of a method for processing changing data, operative in accordance with a preferred embodiment of the present invention; and

FIGS. 3B through 3J, taken together, constitute a simplified pictorial illustration of a sample data set constructed from a changing data set, operative in accordance with a preferred embodiment of the present invention.

### DETAILED DESCRIPTION OF PREFERRED EMBODIMENTS

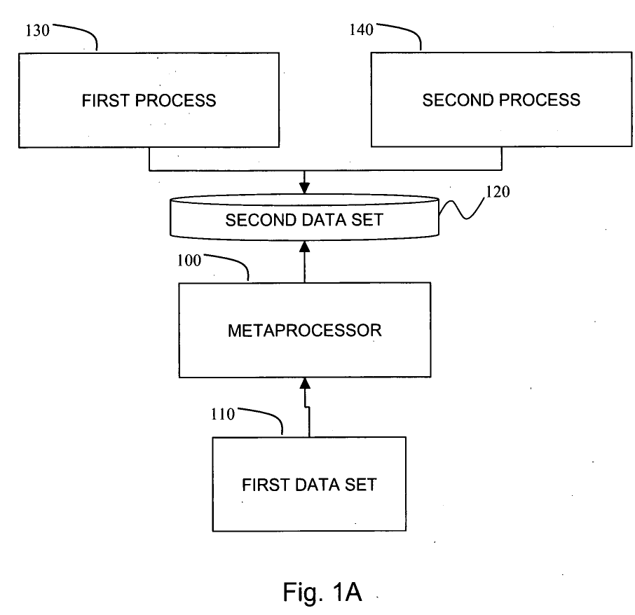

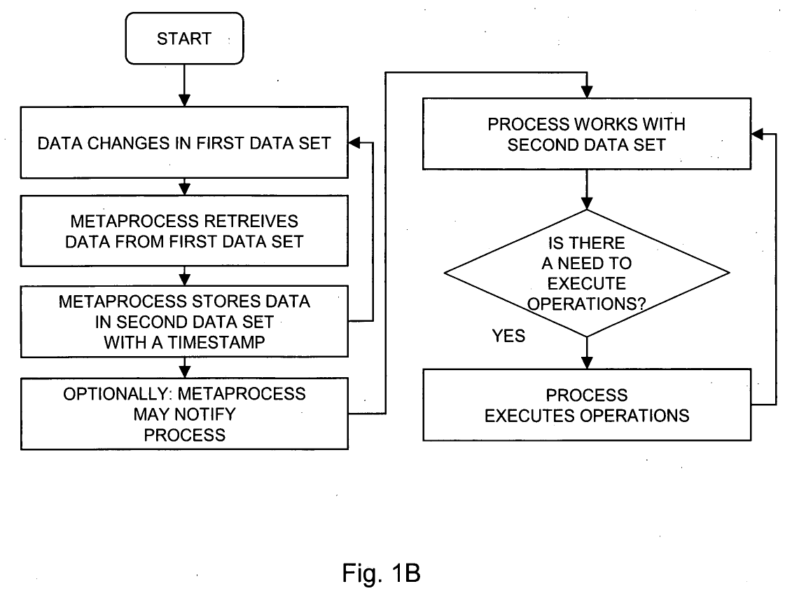

Reference is now made to FIG. 1A, which is a simplified pictorial illustration of a system for concurrent processing of data, constructed and operative in accordance with a preferred embodiment of the present invention, and to FIG. 1B, which is a simplified flowchart illustration of a method for concurrent processing of data, operative in accordance with a preferred embodiment of the present invention. A metaprocess 100 preferably retrieves units of data, such as records, from a first data set 110, such as a flat file, at fixed periods in time that may be scheduled in advance. With each subsequent retrieval, metaprocess 100 preferably retrieves only newly arrived or modified units of data, such as units of data that were not retrieved from first data set 110 during a previous retrieval.

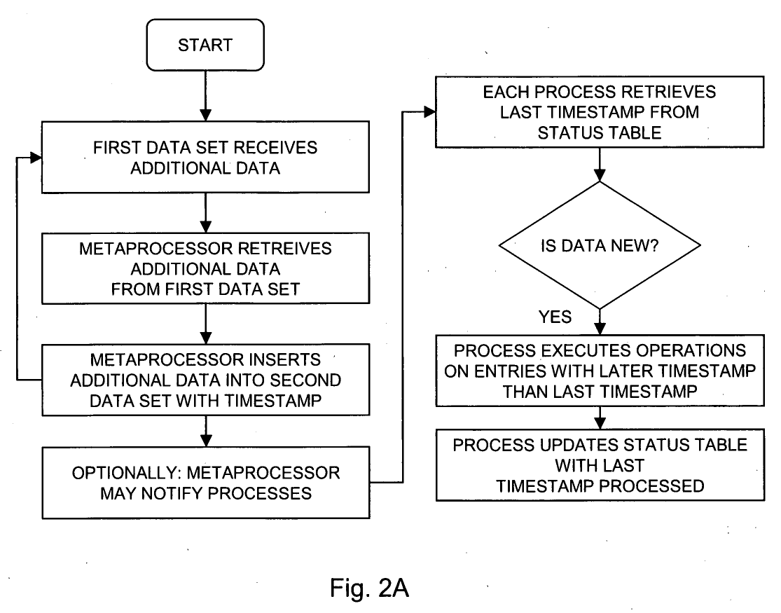

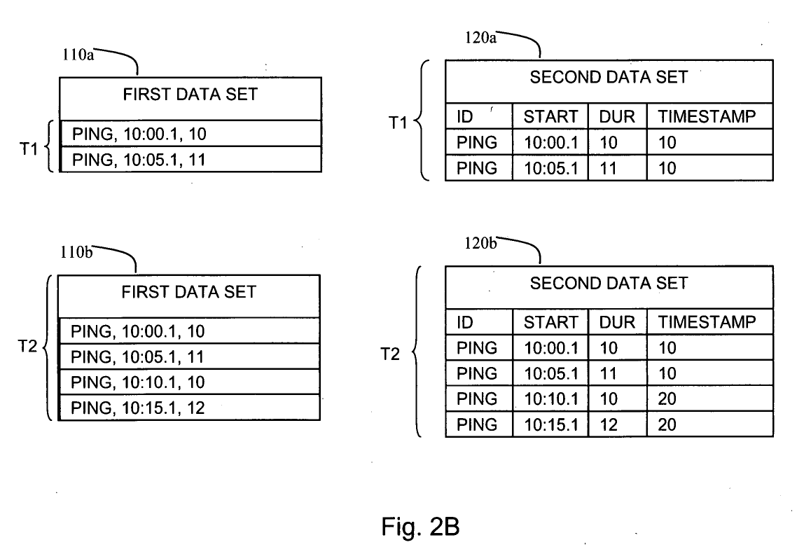

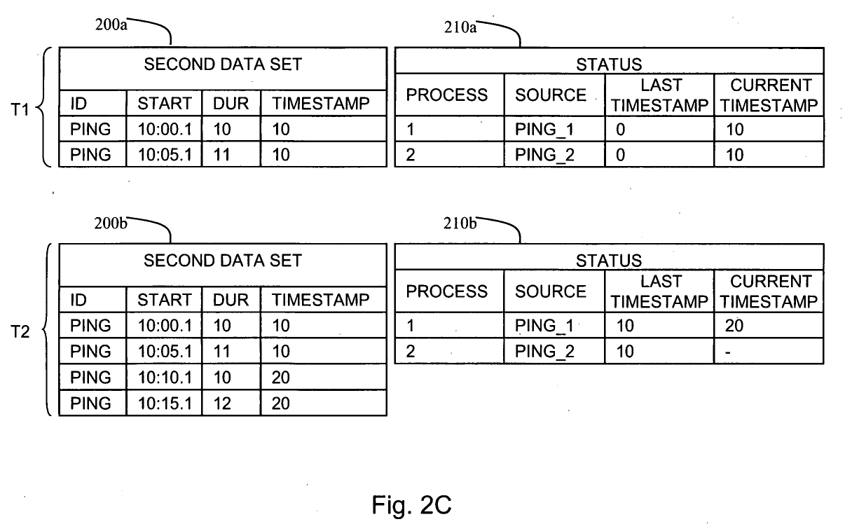

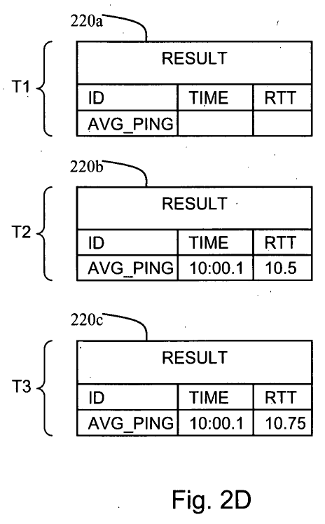

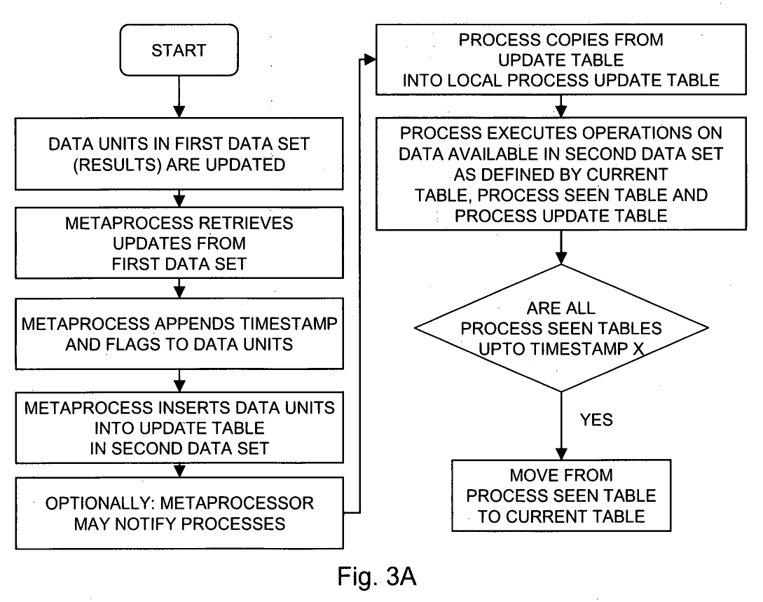

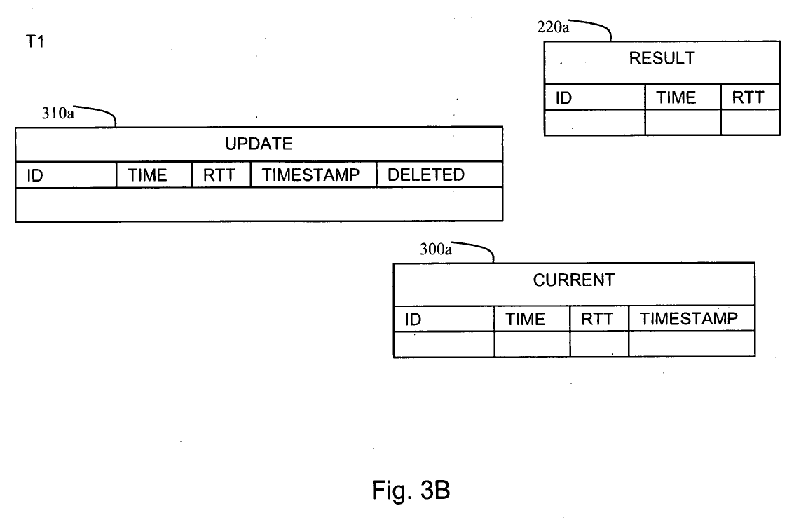

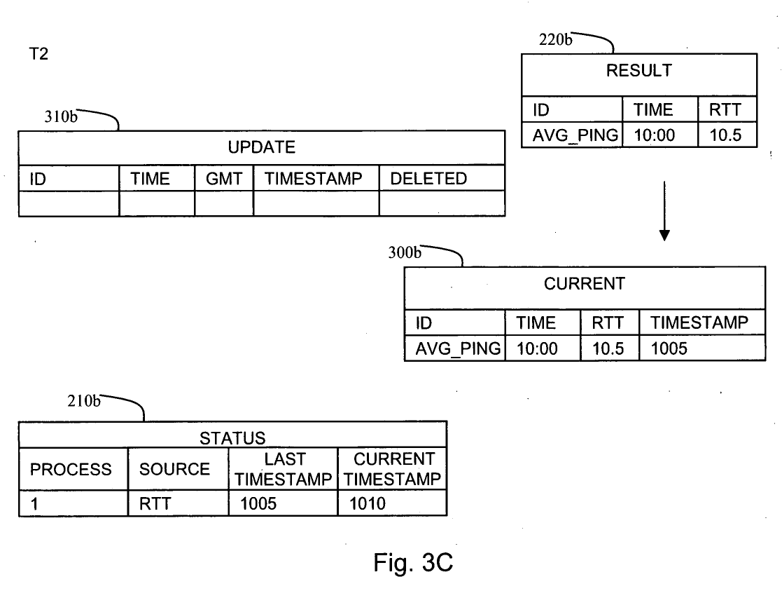

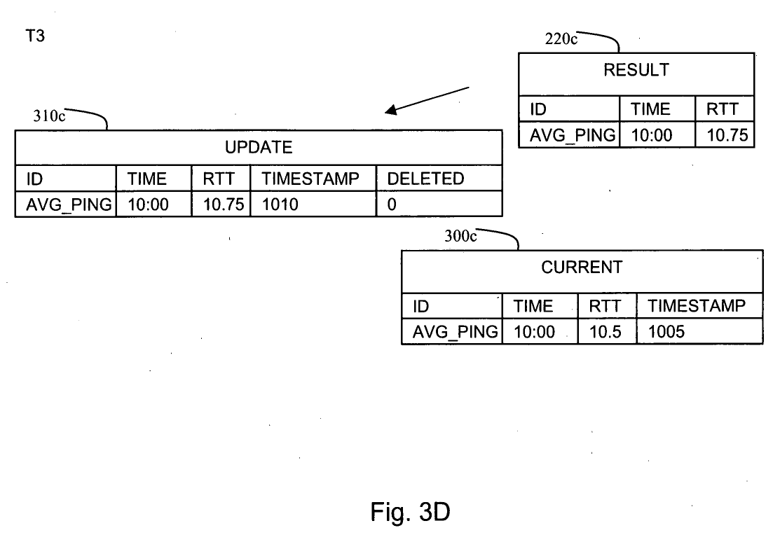

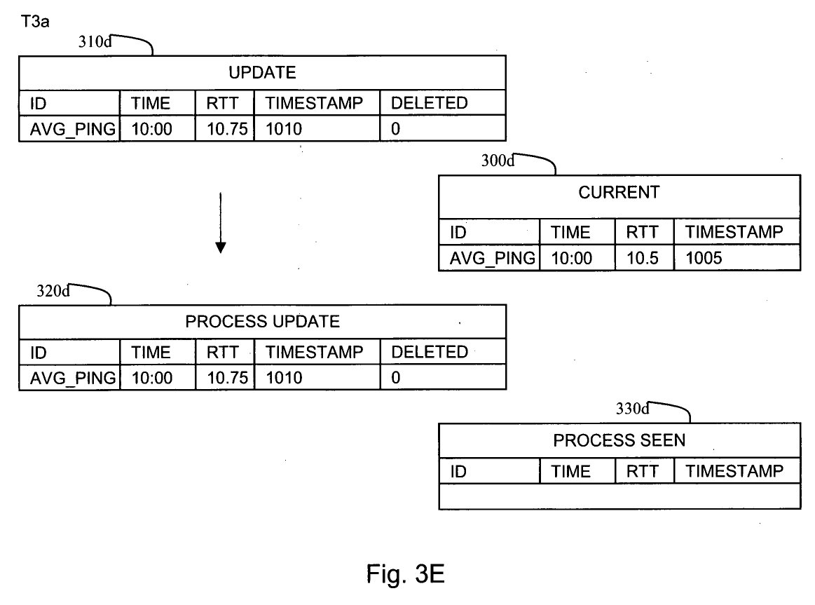

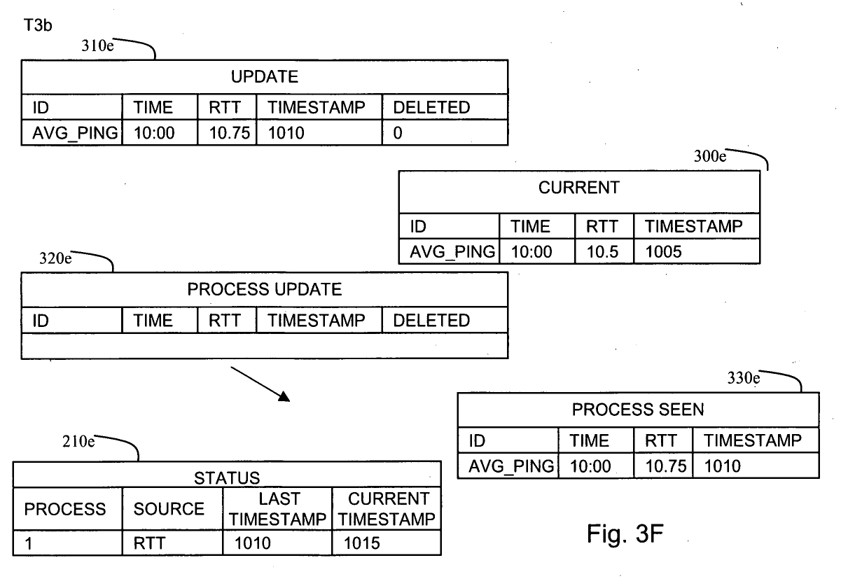

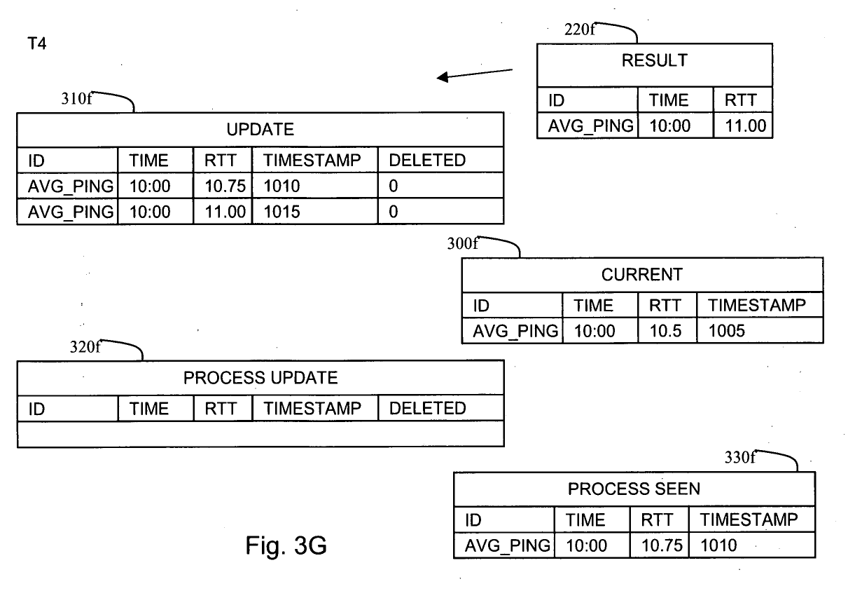

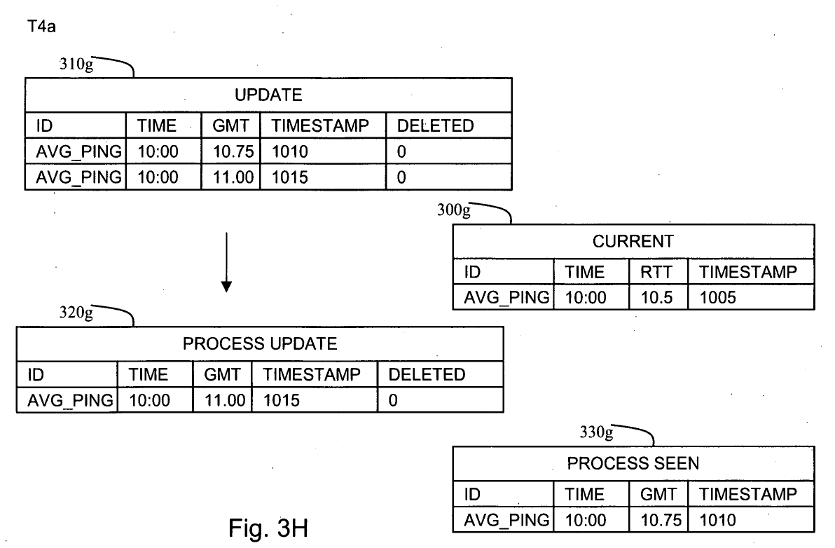

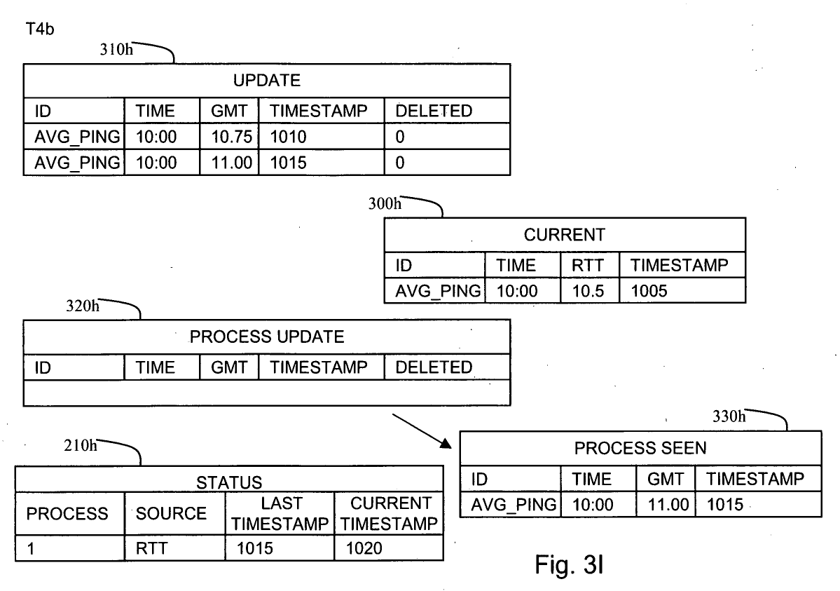

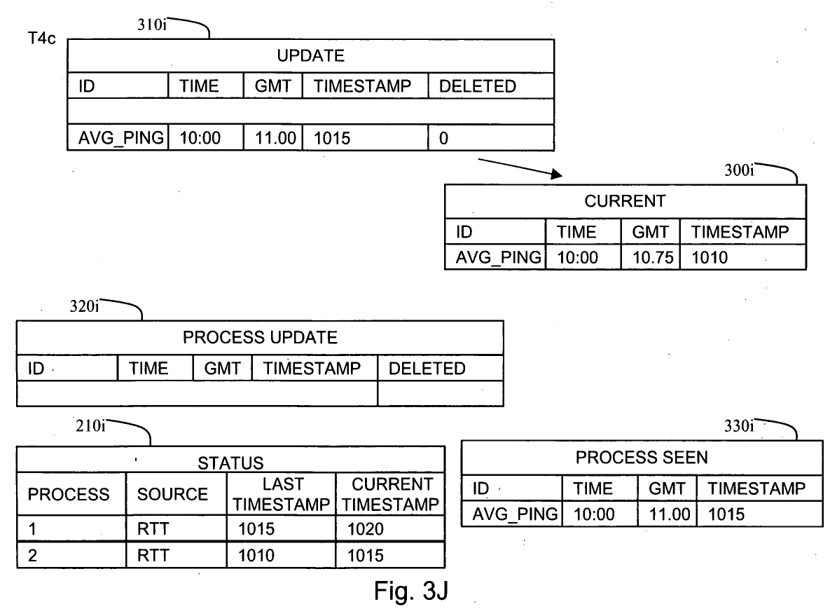

Metaprocess 100 preferably appends a timestamp to each unit of data retrieved from first data set 110 and stores the unit of data with the appended timestamp in a second data set 120, preferably into a set of tables in second data set 120 for future processing as described hereinbelow with reference to FIGS. 2A through 3J.

Metaprocess 100 preferably compares the data units currently in first data set 110 with the data found in second data set 120 to determine which data has been changed, i.e., modified, inserted or deleted. In addition, metaprocess 100 may maintain information regarding the units of data retrieved, such as a new data indicator or an indication of the location of the previously retrieved unit of data from first data set 110 or a flag indicating units read, and subsequently may detect the existence of modifications to first data set 110, such as by determining whether any units of data have been added after the current indication of the location of the previously retrieved unit of data or whether units of data have been deleted or updated by checking if the flag indicating units read has been reset Metaprocess 100 may then notify another process, such as a first process 130, indicating that new data units have been inserted into second data set 120. When metaprocess 100 notifies a process that new data has been inserted, metaprocess 100 preferably communicates the timestamp of the last item inserted. The process may then process the data items in second data set 120 that have a timestamp which indicates the time of, or a time prior to, the communicated timestamp. Each process preferably retains a new data indicator, which stores the last timestamp which was communicated by metaprocess 100 the last time the process was active. A process may then employ the new data indicator to determine if new data, being data with a more recent timestamp than the timestamp preserved by the new data indicator, has been inserted, as described in greater detail hereinbelow with reference to FIG. 2C.

Each process preferably executes one or more operations, such as aggregate operations, on the data units found in second data set 120. The process preferably only executes operations where changes in their associated data units require a recalculation. Thus, although new data units may have been inserted into second data set 120, the process need not necessarily re-execute its operations.

In general the modification to a data set may take one of two forms. In the first form new data units that arrive subsequent to old data units are additive or independent of the old data units. In the second form, the new data units that arrive subsequent to old data units affect the old data units, such as by providing instructions that cause an old data unit to be modified or deleted.

Reference is now made to FIG. 2A, which is a simplified flowchart illustration of a method for processing additive data operative in accordance with a preferred embodiment of the present invention, and FIGS. 2B, 2C and 2D, which, taken together, constitute a simplified pictorial illustration of a sample data set constructed from an additive data set, operative in accordance with a preferred embodiment of the present invention. It is appreciated that any of the tables described herein sharing the same reference number followed by a different reference character may be understood to represent a point-in-time snapshot of the contents of the same table and not as representing a separate table. In the method of FIG. 2A, a first data set 110 receives data units, such as from a ping server that appends a new data unit every 5 seconds. Each data unit, in the example shown in FIG. 2B, includes a single line with multiple comma-delimited fields. The fields include the word ‘PING’ that identifies the source as a ping server, the time of the originating ping and the round trip time (RTT). At time ‘T1’, two data units have been appended to first data set 110a; the first data unit describes a ping that originated at 10:00.1 and had an RTT of 10 ms, while the second describes a ping that originated at 10:05.1 and had an RTT of 11 ms. At time ‘T2’, an additional two data units have been appended to first data set 110b, bringing the total number of data units to four.

In the example depicted in FIG. 2B, metaprocess 100 retrieves the data units from first data set 110 every ten seconds and inserts the data units into a second data set 120. At T1, metaprocess 100 retrieves the two data units from first data set 110a, adds the current timestamp, 10, to each data unit, and inserts the data units into second data set 120a.

Additionally, metaprocess 100 retains a new data indicator, which indicates the end of the last data unit in first data set 110 as it appeared at the point in time depicted in 110a. At T2, metaprocess 100 scans first data set 110 as it appears at the point in time depicted by 110b and determines that two new data units have been appended beyond the last data unit pointed to by the new data indicator. Metaprocess 100 preferably reads the two new data units, adds the current timestamp, 20, to each data unit and inserts them into second data set 120b. Metaprocess 100 may then increment the current timestamp and notify each process of the arrival of new data in second data set 120, indicating the current timestamp.

A process, such as first process 130, may execute one or more operations with the data in second data set 120 and store the timestamp of the latest processed data unit together with the current timestamp in a status table, such as shown in FIG. 2C as status 210a. Each process preferably executes its operations with data units found in second data set 120 that have a timestamp that is after the last timestamp and before the current timestamp stored in the status table. Each process may further take into account any other data available to it as it may require.

In the example shown in FIGS. 2C and 2D, at T1, status table 210a has two entries. Each entry in status table snapshot 210a includes an identifier of each process in the first column, such as where first process 130 is labeled ‘1’ and second process 140 is labeled ‘2’, followed by the source of the data in the second column, a copy of the last timestamp processed in the third column, and the current active timestamp in the fourth column. Thus, in FIG. 2C at time T1, both processes 130 and 140 are active. First process 130, whose input source was ping 1, is processing all the data whose timestamp is greater than 0 and smaller than 10, and similarly second process 140, whose input source was ping 2, is processing all the data whose timestamp is greater than 0 and smaller than 10. At time T2, first process 130 is active, while second process 140 is not. First process 130 processes all the data whose timestamp is greater than 10 and smaller than 20, while second process 140 is not active.

In the example shown in FIGS. 2C and 2D, first process 130 performs an ‘average’ operation to calculate the average RTT based on the data units received from the ping server in first data set 110 as made available in second data set 120. The results of the operation, the average RTT depicted in FIG. 2D, is stored in a result table along with the start time of the ping server, which is stored in the column labeled ‘time’. At T1, no results are available in results table 220a. At T2, first process 130 has calculated the average RTT for the first two data units in second data set 120a, and stored the result, 10.5, in the column labeled ‘RTT’ in results table 220b. At T3, the process has calculated the average RTT for all four data units in second data set 120b and has updated the result, 10.75, in the column labeled ‘RTT’ in results table 220c.

Reference is now made to FIG. 3A, which is a simplified flowchart illustration of a method for processing changing data, operative in accordance with a preferred embodiment of the present invention, and to FIGS. 3B through 3J, which taken together constitute a simplified pictorial illustration of a sample data set constructed from an changing data set, operative in accordance with a preferred embodiment of the present invention. In the method of FIG. 3A, metaprocess 100 retrieves data units that have been modified or are to be deleted from a first data set 110, such as the average RTT found in results table 220a, 220b and 220c described above with regard to FIG. 2D. Metaprocess 100 preferably appends a timestamp as described above and a flag to the data units indicating if the data unit has been modified or is to be deleted. Metaprocess 100 then inserts the data units in second data set 120 as described hereinbelow.

Metaprocess 100 preferably employs two global tables in second data set 120, a current table, which retains the most current data units common to all processes, and an update table, which retains data units that have been read from the changing data available in first data set 110. These data units, which represent changes in first data set 110, may override existing data units. For example, the value of the RTT in the result table shown in FIG. 2D changes from 10.5 to 10.75 between times T2 and T3. The new value of 10.75 may be added to the update table while the old value remains in the current table. A process may then identify the fact that the new value available in the update table overrides the previous value found in the current table and act accordingly, such as is described in greater detail with reference to applicant/assignee's co-pending US patent application entitled “A method for aggregate operations on streaming data,” filed Jun. 16, 2005, the disclosure of which is incorporated herein by reference.

Update table 310a may also include an indicator, such as a column labeled ‘deleted,’ as shown in FIG. 3B, which indicates if the row has been identified as an overriding data unit, in which case a predetermined insert value, such as 1, is entered in the delete column otherwise a predetermined delete value, such as 0, is inserted in the delete column.

Additionally, second data set 120 preferably includes two local tables for each process, a process_update table, which retains changes that have been read from the update table and are particular to a process, and a process_seen table, which preferably retains the unique data units that have been processed by a particular process as described in greater detail hereinbelow.

In the example depicted in FIG. 3B, first data set 110 includes result table 220a. Metaprocess 100 retrieves data units, the average RTT, that have been modified in result table 220a, shown in FIG. 2D, and then inserts the data units into the tables in second data set 120 as described above and demonstrated below. In the current example, first process 130 may be a Service Flow process as described in applicant/assignee's U.S. patent application Ser. No. 11/027,673, filed Jan. 3, 2005, and entitled “A System for Parameterized Processing of Streaming Data,” which executes operations on the data units found in second data set 120 to determine the overall performance of a network.

At a first time step, T1, there are no data units available in results table 220a. Consequently, metaprocess 100 has no data to process in first data set 110 and second data set 120, which includes current table 300a, and update table 310a, is empty. First process 130 analyzes second data set 120 and determines that since there is no data available in any of the tables in second data set 120 it is unable to execute its operations as of yet.

At T2, shown in FIG. 3C, the entry in result table 220b is modified, whereupon metaprocess 100 preferably copies the modified entry in result table 220b, into current table 300b, adding a timestamp, 1005, to the row. First process 130 preferably executes its operations on the newly available data in current table 300b, and saves the last timestamp, 1005, together with the current timestamp 1010, in status table 210b, in the row dedicated to first process 130, labeled ‘1’, and to the source of first process 130, labeled ‘RTT’.

At T3, shown in FIG. 3D, metaprocess 100 detects that the data in results table 220c, has changed, and it inserts a new row in update table 310c, adding a timestamp, 1010.

At T3a, shown in FIG. 3E, first process 130, finds new data in update table 310d that has arrived after the last timestamp and before the current timestamp preserved in status table 210. First process 130 preferably copies the data from update table 310d to process_update table 320d, and if multiple versions of the same data unit exist the latest version is used. First process 130 then executes its operations on all data available in the current table 300d, process_seen table 330d, and process_update table 320d, where data that is marked as deleted, as described above, is treated as such. In this manner first process 130 may execute its operations on data units that incorporate the modifications in first data set 110 while second process 140 may execute its operations on the data units originating from first data set 110 without incorporating the latest modifications performed on the data units in first data set 110.

At T3b, shown in FIG. 3F, after the conclusion of the execution of first process 130's operation, first process 130 preferably moves the data units from process_update table 320e, to process_seen table 330e. First process 130 then preferably moves the current timestamp, 1015, to the latest timestamp, 1010 in status table 210d.

At T4, shown in FIG. 3G, metaprocess 100 detects that the data units in result table 220f, have changed and inserts a new row in update table 310f, adding a timestamp, 1015.

At T4a, shown in FIG. 3H, first process 130 finds new data in update table 310g that has arrived after the last timestamp and before the current timestamp preserved in status 210. First process 130 preferably copies the data from update table 310g, to process_update table 320g, and moves the current timestamp, 1020, to the latest timestamp, 1015, in status table 210g. First process 130 then executes its operations on all the unique data available in current table 300g, process_seen table 330g, and process_update table 320g.

At T4b, shown in FIG. 31, after the conclusion of the execution of first process 130's operation, first process 130 moves the data units from process_update table 320h, to process_seen table 330h. Process_seen table 330 preferably overwrites any older existing copies of the data.

Additionally, metaprocess 100 preferably scans the status table and determines the greatest common timestamp (GCT), which indicates the latest timestamp which all the processes have processed. Metaprocess 100 preferably moves data units that are common, i.e. have a timestamp which is less than or equal to the GCT, from the update table into the current table updating the old values in the current table. In addition, first process 130 removes data units from each of the process_seen tables that have the same timestamps as the records in the current table. Hence, in the example shown in FIG. 3J, at time T4c, although first process 130 has stored the last timestamp 1015 in status table 210i, second process 140 has only stored the last timestamp 1010. Thus, the GCT is determined to be 1010 and the data units with timestamps less than or equal to 1010 are moved from update table 310i, to current table 300i, overwriting any existing older versions of the data. In addition, common data units are removed from process_seen table 330i. In this manner, duplicate information may be removed from second data set 120 and minimize the amount of storage space utilized by the system of the current invention.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A method for allowing multiple processes to independently operate on a data set, the method comprising the steps of:
iteratively performing any of the following steps a)-c) in a metaprocess:
a) retrieving a data unit from a first data;
b) associating each of said retrieved units with a timestamp;
c) storing the retrieved data unit together with its timestamp in a second data set,
where any of said data units retrieved in a previous iteration are not again retrieved in a subsequent iteration, and where the timestamp of each subsequent iteration is later than the timestamp of any previous iteration;
iteratively performing any of the following steps d)-e) in a first data process, wherein said first data process runs at least partially concurrently with said metaprocess:
d) retrieving any of said data units from said second data set whose timestamp indicates a time that is prior to a target time;
e) performing an operation on said retrieved data,
where any of said data units retrieved in a previous iteration are not again retrieved in a subsequent iteration, and where said target time in a subsequent iteration is later than the target time of any previous iteration.

2. A method according to claim 1 and further comprising iteratively performing any of the following steps f)-g) in a second data process, wherein said second data process runs at least partially concurrently with said metaprocess and said first data process:
f) retrieving any of said data units from said second data set whose timestamp indicates a time that is prior to a second data process target time;
g) performing a second data process operation on said second data process retrieved data,
where any of said data units retrieved in a previous iteration of said second data process are not again retrieved in a subsequent iteration of said second data process, and where said second data process target time in a subsequent iteration of said second data process is later than the second data process target time of any previous iteration of said second data process.

3. A method according to claim 1 wherein said performing an operation step comprises performing said operation only on said data units retrieved within one of said iterations.

4. A method according to claim 1 and further comprising:
identifying a data disposition action of a data unit in said first data set, being either of a deletion and a modification of said data unit in said first data set;
providing an instruction to effect said data disposition action with respect to said data unit in said second data set; and
applying said instruction during an iteration of said first data process.

5. A method according to claim 2 and further comprising:
identifying a data disposition action of a data unit in said first data set, being either of a deletion and a modification of said data unit in said first data set;
providing an instruction to effect said data disposition action with respect to said data unit in said second data set;
applying said instruction during an iteration of said first data process;
applying said instruction during an iteration of said second data process,
wherein said applications of said instructions do not affect said data unit within said second data set.

6. A method according to claim 5 and further comprising applying said data disposition action to said data unit in said second data set subsequent to said applications of said instructions by said first and second data processes.

7. A method according to claim 1 wherein said performing an operation step comprises performing a database aggregate operation.

8. A method for allowing multiple processes to independently operate on a data set, the method comprising the steps of:
iteratively performing any of the following steps a)-b) in a first data process:
a) retrieving any data units from a data set having a timestamp indicating a time that is prior to a first data process target time;
b) performing a first data process operation on said retrieved data, where any of said data units retrieved in a previous iteration of said first data process are not again retrieved in a subsequent iteration of said first data process, and where said first data process target time in a subsequent iteration of said first data process is later than the first data process target time of any previous iteration of said first data process;
iteratively performing any of the following steps c)-d) in a second data process:
c) retrieving any of said data units from said data set whose timestamp indicates a time that is prior to a second data process target time; and
d) performing a second data process operation on said second data process retrieved data, where any of said data units retrieved in a previous iteration of said second data process are not again retrieved in a subsequent iteration of said second data process, and where said second data process target time in a subsequent iteration of said second data process is later than the second data process target time of any previous iteration of said second data process.

9. A method according to claim 8 wherein said second data process runs at least partially concurrently with said first data process.

10. A system for allowing multiple processes to independently operate on a data set, the system comprising:
a metaprocess operative to iteratively perform any of the following steps a)-c):
a) retrieve a data unit from a first data;
b) associate each of said retrieved units with a timestamp;
c) store the retrieved data unit together with its timestamp in a second data set,
where any of said data units retrieved in a previous iteration are not again retrieved in a subsequent iteration, and where the timestamp of each subsequent iteration is later than the timestamp of any previous iteration; and
a first data process running at least partially concurrently with said metaprocess and operative to iteratively perform any of the following steps d)-e):
d) retrieve any of said data units from said second data set whose timestamp indicates a time that is prior to a target time;
e) perform an operation on said retrieved data,
where any of said data units retrieved in a previous iteration are not again retrieved in a subsequent iteration, and where said target time in a subsequent iteration is later than the target time of any previous iteration.

11. A system according to claim 10 and further comprising a second data process running at least partially concurrently with said metaprocess and said first data process, and operative to:
f) retrieve any of said data units from said second data set whose timestamp indicates a time that is prior to a second data process target time;
g) perform a second data process operation on said second data process retrieved data,
where any of said data units retrieved in a previous iteration of said second data process are not again retrieved in a subsequent iteration of said second data process, and where said second data process target time in a subsequent iteration of said second data process is later than the second data process target time of any previous iteration of said second data process.

12. A system according to claim 10 wherein said second data set is operative to perform said operation only on said data units retrieved within one of said iterations.

13. A system according to claim 10 and further comprising:
means for identifying a data disposition action of a data unit in said first data set, being either of a deletion and a modification of said data unit in said first data set;
means for providing an instruction to effect said data disposition action with respect to said data unit in said second data set; and
means for applying said instruction during an iteration of said first data process.

14. A system according to claim 11 and further comprising:
means for identifying a data disposition action of a data unit in said first data set, being either of a deletion and a modification of said data unit in said first data set;
means for providing an instruction to effect said data disposition action with respect to said data unit in said second data set;
means for applying said instruction during an iteration of said first data process;
means for applying said instruction during an iteration of said second data process,
wherein said applications of said instructions do not affect said data unit within said second data set.

15. A system according to claim 14 and further comprising means for applying said data disposition action to said data unit in said second data set subsequent to said applications of said instructions by said first and second data processes.

16. A system according to claim 10 wherein said means for performing an operation step comprises performing a database aggregate operation.

17. A system for allowing multiple processes to independently operate on a data set, the system comprising:
a first data process operative to iteratively perform any of the following steps a)-b):
a) retrieve any data units from a data set having a timestamp indicating a time that is prior to a first data process target time;
b) perform a first data process operation on said retrieved data, where any of said data units retrieved in a previous iteration of said first data process are not again retrieved in a subsequent iteration of said first data process, and where said first data process target time in a subsequent iteration of said first data process is later than the first data process target time of any previous iteration of said first data process; and
a second data process operative to iteratively perform any of the following steps c)-d):
c) retrieve any of said data units from said data set whose timestamp indicates a time that is prior to a second data process target time; and
d) perform a second data process operation on said second data process retrieved data, where any of said data units retrieved in a previous iteration of said second data process are not again retrieved in a subsequent iteration of said second data process, and where said second data process target time in a subsequent iteration of said second data process is later than the second data process target time of any previous iteration of said second data process.

18. A system according to claim 17 wherein said second data process runs at least partially concurrently with said first data process.
